(19) United States
(12) Patent Application Publication
(10) Pub. No.: US 2005/0075985 A1
(43) Pub. Date: Apr. 7, 2005

(54) Voice authenticated credit card purchase verification

(76) Inventor: Brian Cartmell, Mercer Island, WA (US)

Correspondence Address: John P. Luther;Newman & Newman, LLP, Suite 610, 505 Fifth Avenue South, Seattle, WA, 98104, US

(21) Appl. No.: 10/679,061

(22) Filed: Oct. 3, 2003

(51) Int. Cl. G06F 17/60

(52) U.S. Cl. 705/67

(57) ABSTRACT

The present invention provides a method of completing a purchase transaction which comprises a purchaser ordering over an electronic network goods or services that the purchaser desires to purchase from a merchant vendor with the use of a money transaction card device; supplying identifying information to the merchant vendor pertaining to the purchaser and authorization of the purchaser for use of the money transaction card device; supplying information from the merchant vendor to a transaction processor pertaining to the purchaser and authorization of the purchaser for use of the money transaction card device; establishing a telephone connection from the transaction processor via registered authorized cardholder telephone number to the purchaser, and in which the purchaser is voice enabled to express intent to complete the purchase transaction and to debit the purchaser's account, and optionally to voice identify the purchaser to the transaction processor.

### FIELD OF THE INVENTION

The present invention is related to a method, apparatus and methods of conducting business thereby, for providing a security system to prevent falsification of data, or transmission of falsified data, at or to an external device or arena in credit card purchase transactions, and also to provide a transaction record. More particularly, the inventive method, apparatus, and method of conducting business is related to voice authenticated card purchase verification and voice recorded consummated transactions.

### BACKGROUND OF THE INVENTION

Product and services purchases through Internet and telephone sources, or through other remote arenas, have rapidly increased in recent years, along with the incidence of fraudulent purchase activities. Such fraudulent activity has generally occurred through unauthorized transactional card, e.g. credit/debit card, usage, or by so-inclined cardholders themselves in instances where a transaction, after receipt of services or goods, is disavowed or alleged to not have occurred by the cardholder or otherwise is alleged to have not been authorized. In other instances, transactions oftentimes are not properly recorded, or memorialized in a tangible form, for any number of reasons, including operator or machine error.

All of the above shortcomings in conventional money card purchase transactions are particularly prevalent in card-not-present transactions in mail/Internet and telephone order transactions, which typically have shown a higher fraud or error incidence than in face-to-face transactions.

In typical money-transfer transactional card sales, a customer visits a site, for example, an Internet site, or a retailer or other provider of goods and/or services, and normally initiates the purchase process by completing and submitting a form which may contain, inter alia, the user's name, billing address, zip code, telephone number and, of course, money transactional card number, usually with its expiration date, and other verification information, such as Credit Code Value (CCV), or Visa's Card Verification Value (CVV) or MasterCard's Card Validation Code (CVC). Upon confirmation of the authenticity of the card and/or authorization for its use, products or services, as the case may be, are then transferred or otherwise made available to the would-be purchaser. As is known, such transactional scenarios are rife with undetected unauthorized transactional card usage, stolen cards or card information, and in recent years fraud perpetuated by cardholders themselves. Detection of such fraud is hampered by increased remoteness between purchasers of goods or services and vendors. For example, when a card's magnetic stripe is read at a point of sale terminal, a CVV or CVC can be verified during authorization. However, when the card is not present, the CVV or CVC cannot be validated. To help reduce fraud in a card-not-present environment, CVV2/CVC2 security codes have been implemented in conjunction with card usage. These numbers are usually printed near the signature panel of cards. In remote transactions, card-not-present merchants are to ask the putative cardholder to read the code from the card, and the merchant then asks for CVV2/CVC2 verification during authorization, and the issuer (or processor) validates the codes and relays decline/approve results. It is thought that merchants, by using CVV2/CVC2 results along with Address Verification Service (AVS), can make more informed decisions about whether to accept transactions. However, these measures can be easily avoided by the holder of stolen information, such as a stolen card, with security code information.

To combat fraudulent money transfer card usage various methods have been implemented commercially or have been described in publications. For example, in published U.S. patent application No.: 2002/0007345/A1 (Jan. 17, 2002) to Harris, a commercial transaction verification method is disclosed, in which a cardholder makes a purchase by submitting a credit card number to a merchant, who then submits a transaction approval request to the credit card company. The credit card company then executes a conventional card transaction approval, and also verifies the transaction approval request with the card-holder. Only after the transaction approval is both conventionally approved by the credit card company and verified by the card holder is an approval sent to the merchant. Other embodiments include transaction verification approval initiated by either the card holder or credit card company. Pre-verification of the transaction is also contemplated by several enumerated pre-verification criteria which can be situated in an authorization module. This module compares the transaction approval request with pre-verification criteria, and automatically verifies prices, and transaction dates and times.

U.S. patent Publication No. 2003/0061163 A1 (Mar. 27, 2003), describes a CardSafe™ method for protecting against unauthorized credit card use, which in similar manner as the Harris publication, is said to put final credit card transactional approval in the hands of the cardholder. In this method, when a credit card is used at a remote terminal, a credit card processing company is contacted with the transactional amount and account number. The card holder is concurrently notified by e-mail, telephone, etc., and has the option of either approving or disapproving the credit card transaction by using some wireless or electronic technology. Thus, notwithstanding approval by a card processing company, until or unless the transaction is approved by the credit card holder, the transaction cannot be completed; no credit card transactions can be effectuated in this method without providing the named owner of the credit card an opportunity to approve of, or disapprove, of the transactions. The purpose of this method is said to provide a concurrent method for verifying and authorizing a credit card transaction at the moment a merchant initiates the transaction.

While the methods described above are likely to detect some fraudulent use, they still can be defeated, apparently relatively easily, by a fraudulent holder masquerading as the true holder via Internet e-mail or simple phone call authorization, or by fraudulent use by the cardholders themselves.

The CardSafe™ system designed to work with the method of U.S. 2003/0061163 publication, as shown, relies on final approval or pre-approval by a cardholder which, as discussed, is prone to being circumvented in several ways. Some added protective measures of this reported method include a cardholder having the ability to change her pre-designated number at any time as desired by simply contacting CardSafe™ voicemail after entering a PIN, or secret access code. These methods are also subject to fraudulent usage by the holder of stolen PIN or access code data, or by fraudulent manipulation by a so-minded, unscrupulous cardholder intent on receiving goods or services without paying for them. A further defect in this system appears in a disclosed CardLock™ feature, in which all of the security features can be deactivated by simply contacting a CardSafe™ voicemail system and entering a deactivating function. As is apparent to anyone skilled in the art, or not, any holder of fraudulently obtained PIN and security code information can, of course, easily shut the system down by using this option, and then proceed to obtain goods or services without payment.

Another system is disclosed in U.S. Pat. No. 6,012,144 to Pickett, wherein a method for performing secure credit card purchases using two or more non-secure networks (e.g. Internet, and telephone) is described. This method is said to employ such non-secure networks in a manner in which security is ensured. The method is described as sending sensitive (i.e. secure) data to a remote data store, by sending a first subset of data to the remote store by a first communication path and a first protocol, and then sending a second subset of data to the store by a second communications path using a second protocol. The two data subsets are then said to complete the transaction, with the sensitive or secure data not being able to be understood or mimicked by an unauthorized party. It is thus the combination of pieces of transmitted data that creates information necessary to effect the desired transaction. The method is said to be particularly secure as separate pieces of information are transmitted over two or more separate networks, at separate times using a least two separate technologies which intercept all pieces and assemble the total message.

This reference also discloses the use of an Interactive Voice Response (IVR) system which is said to communicate with a user by voice communication via telephone to prompt the user to enter remaining information in a second message. For completion of both successfully transmitted messages a third message is sent over a secure network to a user's credit card company of choice. Each message is said to be stored in two differently encrypted databases for added security. As further discussed, a user is contacted by, e.g. telephone via Voice Response Unit, which number has been entered by the user from an HTML coded form on her computer. The user then answers the call and enters her personal identification number (PIN), and is guided by the call from IVR to enter any remaining digits of a credit card number, which has been partially transmitted in a first message. The user can enter such data using push telephone buttons or by the user speaking the remaining digits, which is nothing more than sound entry of secure partial verification data through a non-secure medium, all of which is subject to fraudulent usage of improperly obtained PIN and other identification information, and/or fraudulent manipulation from a so-inclined cardholder.

U.S. Pat. No. 5,903,721 to Sixtus describes another method for executing a secure online transaction between a vendor computer and a user computer over the Internet. Here, a user computer transmits a transaction request message to the vendor computer via the computer network, the transaction request comprising user identification data unique to the user computer, and in response to receiving the transaction request, the vendor computer sending a transaction verification request to a trust service computer interconnected to the computer network. The transaction verification request is said to comprise the user identification data, and data indicative of the requested transaction. Next, in response to receiving the transaction verification request, the trust server computer authenticates the user computer by using the user identification data. The method is said to be a complete solution consisting of servers and clients which already have an existing trust relationship, and only need to communicate requests.

In yet another method of purchasing goods or information and the like over a computer network, U.S. Pat. No. 6,049,785 to Gifford describes a system in which merchant computers on a network maintain databases of digital advertisements that are accessed by buyer computers, and in which a network payment system performs payment order authorization backed by accounts in an external financial network system. The payment system obtains account authorization from the external network in real time, with payment orders signed with authenticators that can be based on combinations of secret functions of payment order parameters, transaction identifiers or specified network addresses.

Recently, voice verification capability has been incorporated into authentication/transaction methods. For example, as discussed in U.S. Pat. No. 6,401,066 to McIntosh, a verification system is provided which employs an interactive voice response system or computer program interface capable of obtaining and recording information regarding commitments from an individual or entity, e.g. a commitment to change long distance telephone service providers. Included in this verification method is voice response unit (“VRU”) which is said to be capable of automatically receiving a call and presenting a number of questions to individuals on opposing ends of the line. The VRU records the responses to questions in a digital format, and stores and catalogs the responses on a server or other mass storage device, with the stored responses providing verification of the answers to questions posed by the voice response unit. As further discussed, stored verifications can be retrieved from the server via, e.g., a telephone retrieval system or a computer interface such as the Internet, with such stored responses confirming consent and binding the recorded party to their statements, such as a customer's verbal consent to switch telephone service providers. This method also discloses the employ of a Dialogic card (Dialogic Corp, Parsippany, N.J.) which interfaces with a network card (“T1” card) in a voice response unit comprising a hard disk drive, the TI card, a network LAN card and a PSTN interface card. The dialogic card is said to provide the functionality of voice synthesis and voice recording, and include capability to store digitized voice files. Still another feature provided by this method is speech pattern analysis performed on recoded response recordation, by storing a sampled speech example of a subject and performing a comparison analysis to provide further identification of identity and to reveal if the same party spoke the first speech sample and the later speech sample.

Further, in another rendition of voice authentification methodology U.S. patent publication No. 2002/0190124 (Dec. 19, 2002) to Piotrowski discloses a method for providing voice authentication during a sale transaction through a telephone system or other communication means in which users of the service can require voice authentication as a prerequisite to conduct a conventional credit card or debit transaction. As set out in this method, a speech recognition system is employed to enhance the security of the use of a transaction card in a telephone or duplex communication system by allowing merchants or consumers to verify the credit or debit card transaction using a voice authentication system at the point of sale (“POS”). In this method, a POS terminal is located at a point of sale, such as a retail store or other business establishment. When a consumer approaches the check-out counter, the retail clerk at the counter uses the POS terminal or a card reader coupled to the POS terminal to charge the cost of a product's use to the consumer's credit card account. The cards' bar code is read by an input interface, or is read through a bar code reading terminal coupled to the input interface, which can be, for example, a radio frequency identification (RFID) device which allows for non-contact reading in an environment where barcode labels do not properly perform, or are otherwise impracticable. Identification received from the barcode and the purchase information is then transmitted to the credit card issuing company's server via, e.g., a web browser, to verify the consumer's identity and for receiving purchase approval. As indicated, these functions are achieved by the POS terminal communicating with (by dialing phone numbers of) web servers belonging to credit card issuers and transmitting the identification and purchase data to the respective web server. Upon receipt of identification and purchase identification data, a remote database is then accessed to verify the consumer's credit and identification of the consumer. As further shown in FIG. 3 in this reference voice verification processing is initiated when the POS terminal reads encoded data from a credit card as the card is swiped at a POS terminal or information is manually inputted. Next, the POS terminal establishes a communication channel to the remote web server, which can be a dial or dedicated connection. At this point, it is determined whether a request for voice authentication is requested, which can be made in either real time or a predetermined periodic schedule. If voice authentication is requested, a path connection between the POS terminal and web server of the credit card company is established. The remote server processes the identification data retrieved from the barcode, and requests the user to speak one or more voice responses to verify the user's identity. Voice input or a voice print of the customer is received through a user interface, such as a voice browser, which then transforms the voice input into the corresponding voice print format and forwards same to the remote web server in the form of Voice XML responses. After receiving spoken words, the remote server searches its own database to establish a match with pre-recorded verification reference data of the consumer. As further revealed, voice input can be provided in the form of a telephone input system, a personal digital assistant (“PDA”), a personal computer, or other mobile voice communication devices. A comparison process is then performed to determine if the voice input from the POS terminal is a match with the prerecorded voice reference data, and if there is a match it is indicative of the voice signature of the consumer. If a match is not made, or a failed voice authentication is evident, say, after one or more attempts, the customer's attempted purchase of goods or services cannot be completed. As also related in this method, a customer may be required to call a specified number and speak various combinations of words or numbers which will be stored as a voice verification reference in a database.

In view of the above conventional authentication/security methods, it would be highly desirable to provide a simplistic, highly secure and inexpensive to implement, voice imprint-based card purchase authentication/verification method for use in telephone and Internet on-line store purchase transactions, and also to provide voice imprint receipt protection for the telephone or Internet on-line vendor as a recorded transaction record.

There is also a need for such a system and method for conducting commercial on-line/Internet or telephone money card purchase transactions with improved security features, minimal inconvenience and down time regarding customer purchase authentication and on-line/telephone vendor record keeping while maintaining a high level of security, convenience and efficiency

### SUMMARY OF THE INVENTION

The present invention overcomes the deficiencies and drawbacks of conventional telephone and Internet/on-line money card purchase authentication security systems, and achieves the desires and industry needs as identified above. In accordance with the instant inventive voice authenticated credit card purchase verification method and apparatus, upon contact by a putative telephone or on-line Internet purchaser of goods and/or services of a vendor and use of a money card transactional device, such as a credit/debit card, or one of the American Express type, a card transaction processor is contacted with conventional authentication information and purchase information, such as the amount of the transaction, the account number, credit card number, card expiration date, card member name and address, and telephone number and the like. Concurrently, or sometime thereafter, but preferably substantially contemporaneous with card transactional usage, the putative card user is then contracted via a telephone call by a system telephone calling means vis-à-vis the cardholder's number on file, for example, as stored in a transaction processor database. Upon the telephone call being answered by anyone, the inventive method and apparatus employs means to ask for the cardholder's name and availability, and/or whether the telephone number is correct, i.e. whether the telephone number called is the telephone number on record for the given credit card. If the card holder is available, the putative purchaser is asked to verify, inter alia, the correctness of the telephone number called, and whether the putative purchaser made the purchase from the vendor. If answers to these system questions are in the affirmative, the inventive method and apparatus includes recordation means to record the purchaser's voice characteristics and/or voice imprint in which the purchaser agrees to and validates the charge on her credit card/debit card. In another embodiment, the inventive method also immediately compares the voice recorded data to voice recorded data on file to verify if the putative purchaser's voice signature is that of the record cardholder, and to authenticate or decline the transaction. Once the transaction has been authenticated and consummated a database will be continually updated with such voice imprint authentication data and consummated card transaction receipt data for voice verification protection for telephone and on-line vendors. Assuming a cardholder is not available when a telephone call is placed by inventive method means as for a record telephone number, the inventive method also includes means to reschedule a telephone call (“telephone call reschedule means”) for a later time which can be a time entered by the called telephone party, all of which is recorded in a database to keep a vendor or transaction processor abreast of transactional status.

The inventive method further includes means to record data as to a called telephone number reported to be incorrect. Unless the transaction is voice authenticated as a cardholder of record vis-à-vis a telephone number of record and the transaction is voice approved by the cardholder, the transaction is not completed. Thus, no credit card transaction can be consummated without sampling the putative card user's voice imprint data, or characteristics, and without providing the named owner of the credit card an opportunity to approve, or disapprove, the credit card transaction by recordable storable voice imprint data and characteristics. Further, in accordance with the present inventive method, an unauthorized user of a credit/debit card who gains access to an account would not be able to complete the transaction when confronted with the inventive method for voice authentication and verification of card usage by a vendor or transaction processor substantially contemporaneous with initiation of the transaction. Additionally, as the vendor or transaction processor is now provided with a cardholder voice imprint “receipt” of the consummated transaction, a fraudulent-inclined cardholder/user would be hard pressed to later disavow or plead ignorance of the transaction after receipt of goods or services, or committing to purchase of same with the specific charges recorded against the cardholder's card. Also included in the inventive method is verification/authentication of any electronic transaction by any known biometric means, or combination of biometric means of identification.

These and other advantages and features of the present invention, including other embodiments thereof, are described in detail and will be better understood with reference to the following Detailed Description of Preferred Embodiments in conjunction with the accompanying drawings.

### BRIEF DESCRIPTION OF THE DRAWINGS

FIG. 1 is a schematic diagram illustrating the steps in a method according to several embodiments of the invention.

### DETAILED DESCRIPTION OF PREFERRED EMBODIMENTS OF THE INVENTION

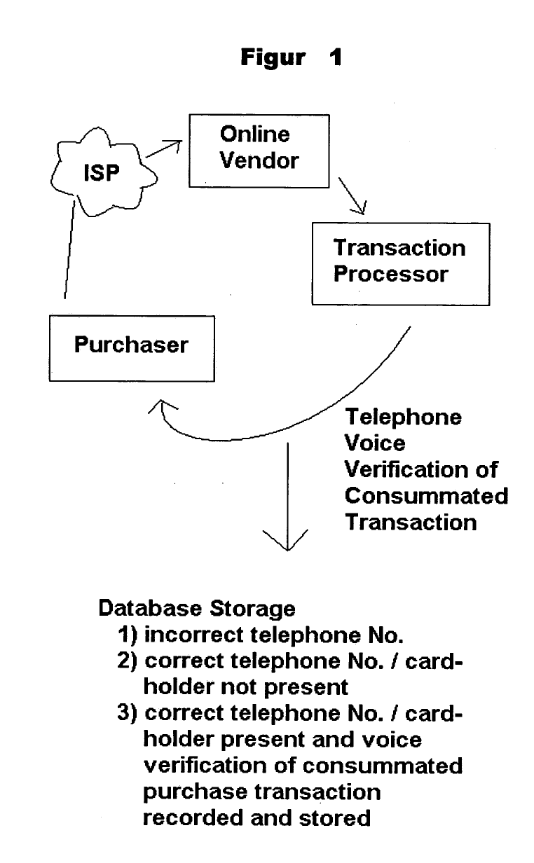

Referring to FIG. 1, when engaged in shopping a customer or otherwise putative purchaser 2, browses for goods and services by using a magazine or sales literature, or a public net-work, such as the Internet or World-Wide Web. Purchaser 2 selects goods or service to be purchased from a merchant via telephone, or as exemplified in this embodiment, by connecting to an on-line vendor site 6 through a local Internet Service Provider (ISP) 4. Purchaser 2 then identifies himself by providing any or all conventional authorization information, including credit card information, credit card code information, name and billing address, PIN, e-mail, address and registered telephone number and the like. Next, merchant/on-line vendor 6 forwards all card purchaser authentication data, together with purchase price and any other information as desired, such as, for example, the merchant's name and telephone number, merchant identification number, a list of items being purchased with the price of each, and the purchaser's registered telephone number to a credit card processing center, or “transaction processor” 8, by e-mail, telephone, or any other means, for example, via an invoice addressed to the transaction processor 8. After processing the supplied authentication data, e.g. credit card number, authorized limit, etc., to consummate the sales transaction, a telephone call is placed to the putative purchaser 2 from the transaction processor 8, or from any means associated with the credit card sale transaction consummation, such as a dedicated network nodule (not shown), or a remote server supplied with database information of registered credit card users, inclusive of a registered telephone number on file in a database accessible by the transaction processor 8. Upon someone answering the telephone, the named credit holder is asked for, and any other identifying questions as desired, such as, for example, voice verification for correctness of the dialed telephone number on file in the database, and whether the dialed telephone number is not correct.

If the cardholder is available, the cardholder will be asked as to the correctness of the called telephone number and to verify and/or otherwise confirm, that they made the purchase from the vendor, all with a voice print recordation to this effect, optionally inclusive of a voice print recordation with the customer-authorized credit card user agreeing to the charges on their credit card and/or to be bound by the terms of the sales transaction. Preferably, the telephone call via the number on file in a database to the putative purchaser is made substantially contemporaneous with the putative purchaser's selection and attempted purchase of goods and/or services via money transaction card, or a soon as practicable, to ensure, and to maintain the highest security integrity of the instant inventive method, that the putative purchaser is an authorized card holder with correct telephone number data on file in a database. Once the recorded purchaser voice print is completed inclusive of all desired information, the database will be continually updated to supply the transaction processor 8 and/or merchant/on line vendor with a recorded voice imprint receipt of the consummated transaction, which can be stored, for example, in a updated library of the customer's consummated sales transactions.

If the cardholder-purchaser 2 is not available at the time of the system telephone call, in accordance with the inventive method, a telephone call via the on-file number will be rescheduled by reschedule means for a later time, all of which such information is recorded in a database for reference by any concerned party, such as the on-line vendor or transaction processor. If the called party indicates that the called number is incorrect, this information will be reported, optionally in a recorded voice imprint to the database as an indication of an attempted fraudulent transaction, or in any event, as a signal or sign to not consummate the transaction. In a further optional embodiment, a voice imprint of the authorized cardholder can be on file in a database or other server library, which is employed in the inventive method as a comparison verification with the voice imprint of the called party as an authentication hurdle to the consummated transaction. If there is not a voice verification match resulting from the comparison test, the transaction processor can consider the attempted transaction to be fraudulent and relay a transaction decline signal or call to the merchant/on-line vendor.

To accomplish the voice verification-voice imprint functions described above, it is contemplated in the present inventive method and apparatus to employ any conventional means to enable a voice transaction process. For example, the system can include an input interface for receiving a transaction request and for initiating a telephone call with an on-file number for the customer voice transaction. The input interface can include a simple recordation device, or any known speech-to-text capability to convert all or part of an audio input from the consumer to electronic text. Also included may be a central processing unit (CPU) a random access memory (RAM) for temporary storage of information, an Internet connection circuit for communicating over the Internet, and a voice browser for providing audio input and output, and a read only memory (ROM) for permanent storage of information, any of which components can be coupled to a bus, in any order or manner desired.

As further contemplated, any or all of the above-described functions, and in FIG. 1, can be implemented via a computer program stored on a computer readable medium. When executed, for example, by the CPU, the program will cause predetermined functions to be executed as described.

As is known, and as contemplated herein, upon initiation of the voice transaction processing of the inventive method, received audio data from a purchaser-cardholder can be used to create a voice data packet, for example, by use of a voice browser capable of transforming the purchaser audio input into a corresponding voice data packet format, such that it can be transmitted in the form of Voice XML responses, HTML, XML and the like. The voice data packet can be transmitted in any form as desired for example, such as a telephone circuit connection.

In verifying the identity of the authorized cardholder by voice authentication as described, the putative purchaser information data inclusive of voice data packet is compared to a pre-stored voice imprint of an authorized cardholder. A pre-stored voice imprint database and voice imprint comparison function can be provided by any conventional means. For example, a voice data packet can be transmitted to a credit card issuing company's server, e.g. transaction processor 8 herein, for verifying the purchaser's identity in a credit card/debit card purchase transaction. Upon receipt of the voice data packet by a system server, a database is accessed to verify the purchaser's credit and identity. In performing this function, the system server, which can be a remote server, searches a database to establish a match with the pre-recorded reference voice data of the authorized cardholder, and a comparison process initiated. A voice reference match indicates that the voice signature of the stored voice reference data matches the voice signature of the purchaser's inputted voice data, and that the putative purchaser/card user is probably genuine and authorized, and the purchase transaction authorized and consummated. If a voice signature match is not established either/or the putative purchase or on-line vendor can be notified, and the sales transaction—card usage declined. Optionally, a failed authentication attempt may trigger inactivation of a credit or debit card, and/or the appropriate authorities notified. Voice authentication or voice recognition is well known in the art, an example of which is the Home Shopping Network Speaker recognition. Voice authorization is also discussed in detail, for example, in U.S. Pat. Nos. 5,835,894, 5,499,288; 5,127,043; 5,297,183, Japanese patent application Nos. 2001265741, 2002176455, 03262344, 63193694, 10331498, 02073744 and 2002176455, the disclosures of which are incorporated herein by reference.

Also contemplated for use in the present invention to deter unauthorized financial transactions, and to strengthen financial and credit privacy are any conventional biometric means of identification, some non-limiting examples include, fingerprints, thumbprints, retinal patter, face fingerprint, electronic signatures, cryptographic digital signatures keystroke dynamics, wrist vein identification, hand geometry scans and dynamic and static handwritten signature in combination of biometric means of identification, particularly that which cannot be reverse engineered to recreate personal information. A commercial example is Disney's hand geometry scans of season ticket holders. Electronic signatures are recognized under the Electronic Signatures in Global and National Commerce Act (“e-sign”), which authorizes the use of electronic means to meet legal requirements in contracts, consumer disclosures and record keeping. As defined by the Act, and the scope thereof contemplated for use herein, in one ore more embodiments, electronic signature encompasses electronic sound, symbol, or process attached to or logically associated with, a contract or other record and executed or adopted by a person with the intent to sign the record.

Additional examples of biometric identification means include that or U.S. Pat. No. 6,208,264 which discusses a financial transaction customer carrying a card key containing a unique machine-readable code, which is an encrypted data set representing the user's fingerprint in scanable/laser readable form, and which must match previously recorded data as an indication of satisfactory identification. The disclosed system also includes a centralized database containing data and processing software for recognizing the encoded card keys of the system as well as to data and processing software for authenticating a user's thumbprint with a network linking the centralized database to a plurality of remote terminals or sites where identification is required.

U.S. patent application Publication No. 20020163412 which discloses a method of bank card and credit card fingerprint identification. As disclosed in this method, a reference fingerprint data is digitized and stored in an IC chip or stored on a magnetic strip of a bank card or credit card. The true, authorized user is identified by collating the measured fingerprint data with the reference fingerprint data via a fingerprint ATM terminal, or a fingerprint reading device. The disclosure of both of these references are incorporated herein by reference.

Thus, as contemplated in the present invention, any biometric identification means may be encoded on a machine-readable card key with an encrypted data set representing the user's face print, fingerprints, hand geometry and like, which is scanable/laser-readable, or which can be transmitted by any know or conventional means e.g. by palm or hand held wireless electronic mail, computing or transmitting device, or through dedicated remote terminal in conjunction with establishing a telephone connection from the transaction processor, preferably substantially contemporaneously, with a purchaser's order or attempted purchase, or goods or service.

The remote server may also be inter/intra connected to secondary web servers to implement other verification processes, such as, for example, to form and transmit a voice data packet to a police department, or Interpol, or telephone company to comparison match a voice signature of known fraudulent card users and to coordinate his present geographical location.

Although the present invention has been described in relation to particular embodiments, it is to be understood that such are intended as illustrative examples only, and are not intended to be limiting of the scope or spirit of the invention and claims, as many other variations and modifications, and other uses, will become apparent to those skilled in the art.

1. A method of completing a purchase transaction comprising,
a) a purchaser ordering over an electronic network a good or service that the purchaser desires to purchase from a merchant vendor with the use of a money transaction card device;
b) supplying identifying information to the merchant vendor pertaining to the purchaser and authorization of the purchaser for use of the money transaction card device;
c) supplying information from the merchant vendor to a transaction processor pertaining to the purchaser and authorization of the purchaser for use of the money transaction card device;
d) establishing a telephone connection from the transaction processor via registered authorized cardholder telephone number to the purchaser, and in which the purchaser is voice enabled to express intent to complete the purchase transaction and to debit the purchaser's account, and optionally to voice identify the purchaser to the transaction processor.

2. The method of claim 1, further comprising the step of debiting an account of the customer and crediting an account of the merchant vendor.

3. The method of claim 1, wherein step d) establishing a telephone connection from the transaction processor to purchaser is accomplished substantially contemporaneously with purchaser's order of goods and/or services.

4. The method of claim 1 further comprising the step of confirming to the purchaser and/or merchant vendor that the purchase has been consummated.

5. The method of claim 1 further comprising the step of the transaction processor reiterating by registered telephone number call to purchaser that purchaser has made a plurality of orders and enabling purchaser by voice instruction to select from among those orders to consummate one or more transactions.

6. The method of claim 1 further comprising in step d) of identifying the purchaser to the transaction processor by biometric means of identification, including face print, fingerprints, thumbprints, retinal pattern electronic signatures, cryptographic digital signatures, key stroke dynamics, wrist-vein identification, hand geometry scans, and dynamic and static handwritten signature in addition to voice recognition, or any combination thereof.

7. Apparatus for completing a purchase transaction comprising;
a) a purchaser ordering over an electronic network a good or service that the purchaser desires to purchase from a merchant vendor with the use of a money transaction card device;
b) supplying identifying information to the merchant vendor pertaining to the purchaser and authorization of the purchaser for use of the money transaction card device;
c) supplying information from the merchant vendor to a transaction processor pertaining to the purchaser and authorization of the purchaser for use of the money transaction card device;
d) establishing a telephone connection from the transaction processor via registered authorized cardholder telephone number to the purchaser, and in which the purchaser is voice enabled to express intent to complete the purchase transaction and to debit the purchaser's account, and optionally to voice identify the purchaser to the transaction processor.

8. The apparatus of claim 7 further comprising apparatus for debiting an account of the customer and crediting an account of the merchant vendor.

9. The apparatus of claim 7, wherein step d) establishing a telephone connection from the transaction processor to purchaser is accomplished substantially contemporaneously with purchaser's order of goods and/or services.

10. The apparatus of claim 7 further comprising the step of confirming to the purchaser and/or merchant vendor that the purchase has been consummated.

11. The apparatus of claim 7 further comprising the step of the transaction processor reitering by registered telephone number call to purchaser that purchaser has made a plurality of orders, and enabling purchaser by voice instruction to select from among those orders to consummate one or more transactions.

12. The apparatus of claim 7 further comprising in step d) of identifying the purchaser to the transaction processor by biometric identification means, inclusive of face print, fingerprints, thumbprints, retinal pattern, electronic signatures, cryptographic digital signatures, keystroke dynamics, wrist-vein identification, hand geometry and dynamic and static handwritten signature, or any combination thereof.

13. A method of conducting business comprising completing a purchase transaction comprising:
a) a purchaser ordering over an electronic network a good or service that the purchaser desires to purchase from a merchant vendor with the use of a money transaction card device;
b) supplying identifying information to the merchant vendor pertaining to the purchaser and authorization of the purchaser for use of the money transaction card device;
c) supplying information from the merchant vendor to a transaction processor pertaining to the purchaser and authorization of the purchaser for use of the money transaction card device;
d) establishing a telephone connection from the transaction processor via registered authorized cardholder telephone number to the purchaser, and in which the purchaser is voice enabled to express intent to complete the purchase transaction and to debit the purchaser's account, and optionally to voice identify the purchaser to the transaction processor.

14. The method of conducting business of claim 13 further comprising the step of debiting an account of the customer and crediting an account of the merchant vendor.

15. The method of conducting business of claim 13 wherein step d) establishing a telephone connection from the transaction processor to purchaser is accomplished substantially contemporaneously with purchaser's order of goods and/or services.

16. The method of conducting business of claim 13 further comprising the step of confirming to the purchaser and/or merchant vendor that the purchaser has been consummated.

17. The method of conducting business of claim 13 further comprising in step d) of identifying the purchaser to the transaction processor by biometric identification means, inclusive of face print, fingerprints, thumbprints, retinal pattern, electronic signatures, cryptographic digital signatures, keystroke dynamics, wrist-vein identification, hand geometry and dynamic and static handwritten signature, or any combination thereof.
